(19) United States
(12) Patent Application Publication
(10) Pub. No.: US 2007/0214466 A1
(43) Pub. Date: Sep. 13, 2007

(54) Self-cleaning data storage disk

(75) Inventors: Mikio Obikane, Kanagawa (JP); Yuki Kanemaru, Tokyo (JP)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/372,155

(22) Filed: Mar. 9, 2006

(51) Int. Cl. G11B 7/24; G11B 23/03

(52) U.S. Cl. 720/718

(57) ABSTRACT

In an embodiment, a data storage disk comprises a data storage layer and a photocatalyst layer on a surface of the data storage disk. The photocatalyst layer may oxidize contaminants on the surface of the data storage disk when the photocatalyst layer is exposed to radiative energy. For example, the radiative energy may be a laser light used to read data from the data storage disk. In this manner, some embodiments of the invention may provide for a data storage disk that cleans itself during a read operation of the data storage disk.

### TECHNICAL FIELD

The invention relates to data storage disks, and more particularly, but without limitation, to optical data storage disks.

### BACKGROUND

Data storage disks are used to store music, computer applications, data files and other information. Examples of data storage disk formats include CD, CD-R, CD-RW, DVD, DVD-R, DVD-RW, DVD+R, DVD+RW, DVD-RAM, HD-DVD, Blu-ray and the like. Other data storage disk formats are also available and include magnetic and magneto-optic formats.

Information on a CD, one type of data storage disk, is retrieved by focusing an energy source, such as a laser, onto a data storage layer of the disk and sensing a reflection of the energy source. For example, information on a standard CD is encoded as a spiral track of pits. The pits alternate with higher lands. The difference in height between pits and lands is generally one quarter to one sixth of the wavelength of the laser light, leading to a half-wavelength or less phase difference between the light reflected from a pit and from its surrounding land. This phase change creates a destructive interference that reduces the intensity of reflected light compared to when the laser is focused on just a land. The relative change in intensity of reflected light is measured by a sensor in order to retrieve data from a CD.

Contaminants, such as dust or fingerprints, on the surface of a data storage disk can interfere with data retrieval from the data storage disk. If there are enough contaminants, a data storage disk or a portion thereof may become unreadable. If too dirty, a data storage disk must be cleaned, e.g., by wiping it with a cloth, before data can be retrieved from the contaminated portions of the disk. However, careless cleaning of a data storage disk can result in scratches to the disk itself. For example, contaminants wiped across the surface of a data storage disk or an abrasive cleaner used to clean a data storage disk may leave scratches on the surface of the data storage disk. In some situations, these scratches can make data retrieval more difficult or even cause complete data loss.

### SUMMARY

In general, the invention is related to data storage disks having a photocatalyst surface layers that dissolve contaminants when exposed to an energy source. For example, in some embodiments, contaminants may be dissolved by an energy source, e.g., a laser light, used to read data from the data storage disks. In other embodiments, contaminants may be dissolved by an energy source unrelated to data retrieval.

In one embodiment, the invention is directed to a data storage disk comprising a data storage layer, and a photocatalyst layer on a surface of the data storage disk.

In another embodiment, the invention is directed to a system comprising a hub sized to receive a data storage disk that includes a photocatalyst layer on a surface of the data storage disk, a motor coupled to the hub that rotates the hub and the data storage disk, and a radiative energy source that emits a radiative energy that activates the photocatalyst layer to clean the surface of the data storage disk.

In another embodiment, the invention is directed to a method comprising determining contaminants are on a surface of a data storage disk, wherein the data storage disk includes a photocatalyst layer on the surface of the data storage disk, and exposing the data storage disk to a radiative energy that activates the photocatalyst layer to clean the surface of the data storage disk

Embodiments of the invention may provide one or more of the following advantages. For example, embodiments of the invention may increase the readability of data storage disks by simultaneously cleaning and reading the data storage disk. By cleaning data storage disks without physically contacting the data storage disks, embodiments of the invention may also reduce damage to data storage disks caused by cleaning. Embodiments of the invention may also provide for backwards-compatibility with conventional data storage disk formats and conventional data storage disk read systems.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A-1B illustrate a data storage disk including a photocatalyst layer.

FIG. 2 illustrates a system for reading data storage disks that includes a radiative energy source for cleaning data storage disks.

FIG. 3 is a flowchart illustrating an exemplary method for initiating a cleaning operation using the radiative light source in the system of FIG. 2.

### DETAILED DESCRIPTION

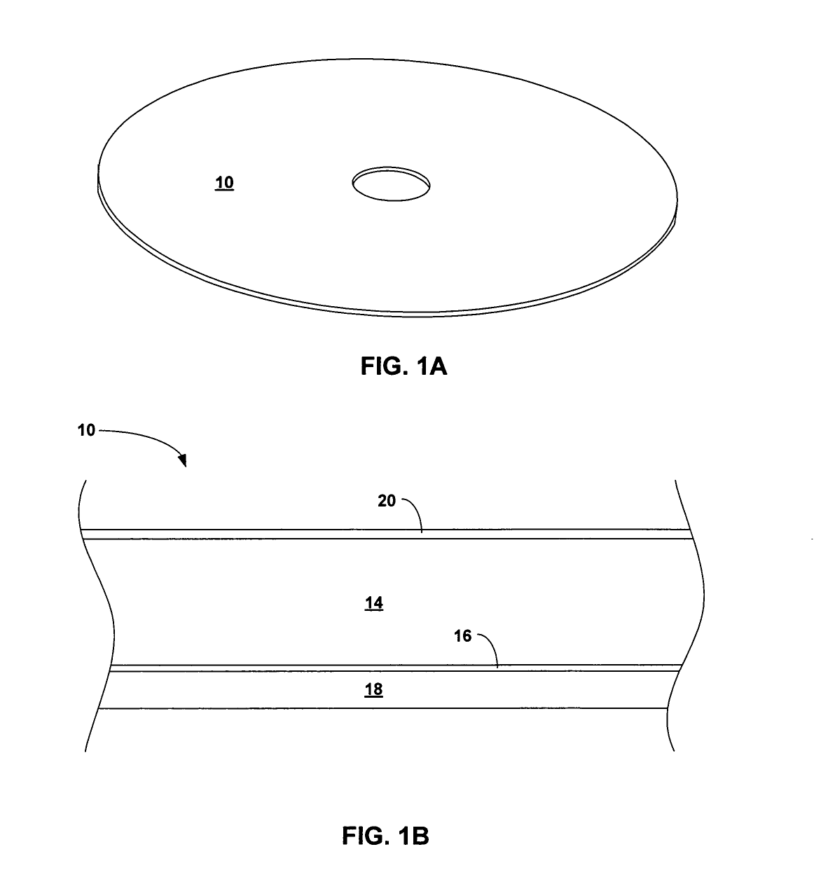

FIGS. 1A-1B illustrate data storage disk 10. In some embodiments, data storage disk 10 may use an optical disk format such as CD, CD-R, CD-RW, DVD, DVD-R, DVD-RW, DVD+R, DVD+RW, DVD-RAM, HD-DVD, Blu-ray and the like. In other embodiments, data storage disk 10 may use a magnetic, magneto-optic or other type of data storage format. Data storage disk 10 is similar to currently existing data storage disks with the addition of photocatalyst layer 20. As such, data on data storage disk 10 can be read by a conventional data storage disk read system. For example, if data storage disk 10 has a CD format, it can be read by a conventional CD player.

As shown in FIG. 1B, data storage disk 10 includes multiple layers. Base layer 14 provides stiffness for the other layers. Data storage layer 16 is below base layer 14 and provides accessible data stored on data storage disk 10. For example, if data storage disk 10 contains an optical format, data storage layer 16 may be a reflective layer. Protective layer 18 is below data storage layer 16. Protective layer 18 covers data storage layer 16 and helps prevent damage to data storage layer 16. Protective layer 18 optionally includes a printed label for data storage disk 10. Photocatalyst layer 20 is above base layer 14 and serves to oxidize contaminants on the surface of the data storage disk when the photocatalyst layer is exposed to radiative energy. In some embodiments, photocatalyst layer 20 may include titanium dioxide.

As an example, if data storage disk 10 is a standard CD, base layer 14 may be polycarbonate plastic, data storage layer 16 may be a reflective metal, such as super purity aluminum or gold, and protective layer 18 may be a lacquer. Assuming base layer 14 is a plastic, such as a polycarbonate, photocatalyst layer 20 must be able to adhere to plastic. A photocatalyst that adheres to and can be coated on a polycarbonate is available from Takiron Co., LTD. of Japan (hereinafter “Takiron”). For example, Takiron markets a transparent polycarbonate plate with a surface treated by a titanium oxide-based photocatalyst under the name “Clean Carbo”, as translated from Japanese. The photocatalyst that adheres to and can be coated on a poly-carbonate available from Takiron includes titanium dioxide. This photocatalyst from Takiron is useful for photocatalyst layer 20 because it oxidizes organic materials and becomes more hydrophilic in response to exposure to radiative energy, such as sunlight or ultraviolet light. In addition to the described photocatalyst available from Takiron, however, other photocatalysts may also be used in accordance with the invention.

Different photocatalysts may react differently to radiative energy sources of different wavelengths. As an example, a photocatalyst may be activated by radiative energy used to read data from the data storage disk. For example, the photocatalyst may be activated by a laser light used to read data storage disk 10. In this case, a conventional drive may activate the photocatalyst to clean the disk during a conventional read of the disk 6. As other examples, the photocatalyst may be activated by a laser light used to write data on the data storage disk or by a laser light used to erase data from the data storage disk. As discussed previously, radiative energy sources other than lasers may also activate the photocatalyst.

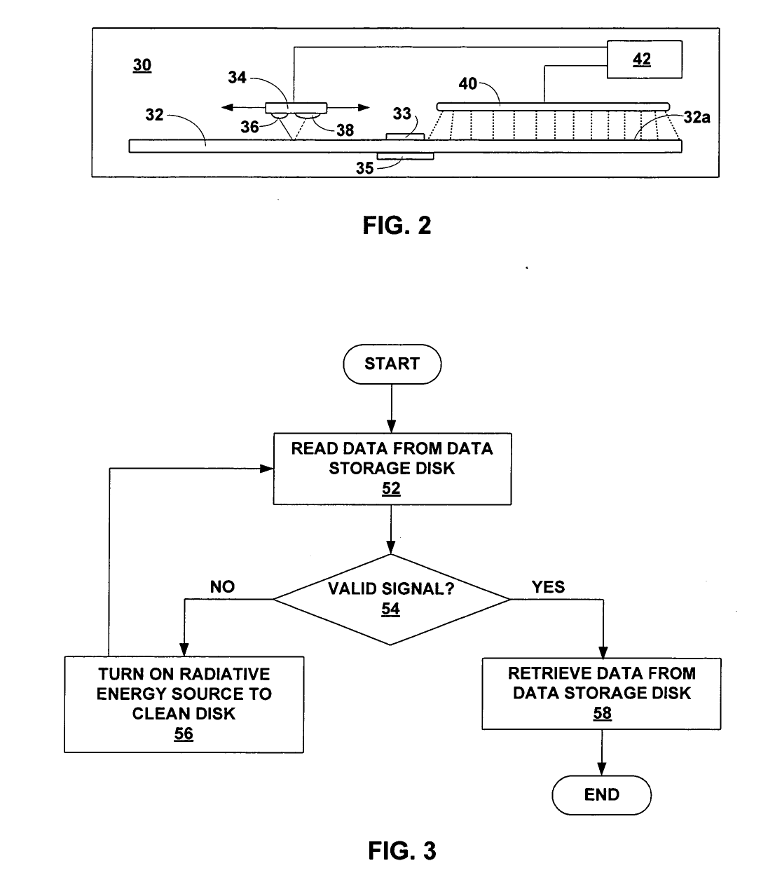

Data storage layer 16 is read by a read module of a data storage disk read system. The read module in a data storage disk read system may use a radiative energy source to read data from data storage disk 10. For example, a CD player uses a laser to read information from a data storage disk. More details regarding a data storage disk read system are available in the text accompanying FIG. 2.

Contaminates may be deposited on the surface of data storage disk 10 and photocatalyst layer 20 during normal use of data storage disk 10. For example, organic contaminants such as fingerprints, dust, molds and bacterium may stick to the surface of data storage disk 10. Because photocatalyst layer 20 is activated by a radiative energy source, simply reading data from data storage disk 10 with a data storage disk read system that uses a radiative energy source can degrade contaminants on the surface of data storage disk 10. This may increase the readability of data on data storage disk 10 and decrease the number of read errors. In some cases, data storage disk 10 may also be activated by a different radiative energy source to degrade contaminants on the surface of data storage disk 10.

The illustrated data storage disk 10 only has a single data storage layer 16. However, in other embodiments, a data storage disk may include multiple data storage layers; for example, multi-layer HD-DVD and Blu-ray data storage disks are currently available. Multiple data storage layers may be read from a single side. In other embodiments, multiple data storage layers may be read from opposite sides of a data storage disk. These embodiments may include a photocatalyst layer on each surface of the data storage disk.

Data storage disk 10 may be substantially manufactured using conventional manufacturing techniques. The addition of photocatalyst layer 20 onto data storage disk 10, however, may require an additional manufacturing process. For example, photocatalyst layer 20 may be added by spin coating on top of base layer 14 or by simultaneous transfer in the process of injection of base layer 14. Photocatalyst layer 20 may be added before or after data storage layer 16 and protective layer 18 are added to base layer 14.

FIG. 2 illustrates data storage disk read system 30 that reads data from data storage disk 32. In system 30, an additional radiation source is included, relative to conventional drive systems, for the purpose of activating a photocatalyst. As noted above, however, the invention may also work with conventional drive systems, in which case the read laser could also perform cleaning functions by activating the photocatalyst.

Data storage disk 32 of FIG. 2 may be the same as data storage disk 10 in FIGS. 1A-1B. System 30 includes hub 33, which is sized to receive data storage disk 32. Motor 35 is coupled to hub 33 and functions to rotate hub 33 and data storage disk 32. Data storage disk read system 30 includes radiative energy source 40. When activated, radiative energy source 40 emits a radiative energy that activates a photocatalyst layer on surface 32a of the data storage disk 32.

Read component 34 retrieves data from data storage disk 32 by focusing a radiative energy source, e.g., a laser, from emitter 36 on a data storage layer of data storage disk 32 and sensing the reflection with sensor 38. Read component 34 can actuate back and forth to read data across the entire surface 32a of rotating data storage disk 32. Other embodiments of the invention, for example, embodiments that utilize magnetic data storage formats, may use different techniques for reading data from data storage disk 32.

Data storage disk 32 is removable, and data storage disk read system 30 can also read other data storage disks. For example, data storage disk read system 30 may be able to read both data storage disks that include and those that do not include a photocatalyst layer.

Radiative energy source 40 emits a radiative energy that activates the photocatalyst layer of data storage disk 32 to clean surface 32a. For example, radiative energy source 40 may emit a radiative energy, such as ultraviolet light, having a substantially different wavelength compared to the wavelength of the radiative energy source produced by emitter 36 to read data from data storage disk 32. The radiative energy emitted by radiative energy source 40 activates the photocatalyst layer on the surface 32a to oxidize organic contaminants on surface 32a.

In this manner, radiative energy source 40 is not required to read data from data storage disk 10. Because it is possible radiative energy source 40 may degrade data storage disk 10 over time, control module 42 may activate radiative energy source 40 periodically or only when necessary to clean data storage disk 32.

FIG. 3 is a flowchart illustrating an exemplary method for initiating a cleaning operation using the radiative light source in the system of FIG. 2. For clarity, the flowchart of FIG. 3 is described with respect to data storage disk read system 30 and control module 42. Control module 42 operates to control read component 34 and radiative energy source 40.

Control module 42 first receives an instruction to retrieve data from data storage disk 32. For example, the data retrieval instruction may be initiated by a user or by an electronic system such as a computer. Control module 42 then attempts to read data from the data storage disk 32 by instructing read component 34 to read data from data storage disk 32 (52).

Control module 42 then determines if read component 34 is able to receive a valid signal from data storage disk 32 (54). If read component 34 is able to read the data from data storage disk 32, control module continues to read the data until all requested information is retrieved from data storage disk 32 (58).

If read component 34 fails to read all or a portion of the data from data storage disk 32, control module 42 activates radiative energy source 40, while motor 35 continues to spin data storage disk 32 (56). Control module 42 continues to attempt to read data from data storage disk 32 while leaving radiative energy source 40 activated to clean data storage disk 32 (52). Once data storage disk 32 is cleaned, read component 34 is able to receive a valid signal from data storage disk 32 (54). Control module 42 then continues to read the data until all requested information is retrieved from data storage disk 32 (58).

In a different embodiment, control module 42 may wait defined amount of time after activating the radiative energy source (56) before reattempting to read the data from the data storage disk (52). In either case, control module 42 may wait a defined amount of time after activating radiative energy source 40 and then deactivate radiative energy source 40. If data is still unreadable from data storage disk 32 after the defined amount of time, control module 42 may indicate that the data is unreadable. For example, control module 42 may indicate that the data is unreadable to a user and instruct the user to manually clean data storage disk 32 before again attempting to read data from data storage disk 32.

The functions of control module 42 may be implemented, for example, by executing instructions of a computer-readable medium with one or more processors, discrete hardware circuitry, firmware, software executing on a programmable processor, or any combination thereof.

Various embodiments of the invention have been described. However, modifications can be made to the described embodiments without departing from the spirit and scope of the invention. For example, dissolution of contaminates on the surface of a data storage disk was described only with respect to a read operation, but the invention is equally applicable to a write operation on a recordable data storage disk. Additionally, a two-sided data storage disk may include two photocatalyst layers, one for each side of the data storage disk. Although FIGS. 2 and 3 illustrate embodiments in which an additional radiation source is used specifically for disk cleaning, the embodiment of FIG. 1 may also find benefit in conventional disk drive systems, in which case the read laser of the system may perform the cleaning functions as it reads the disk.

These and other embodiments are within the scope of the following claims.

1. A data storage disk comprising:
a data storage layer; and
a photocatalyst layer on a surface of the data storage disk.

2. The data storage disk of claim 1, further comprising a base layer between the data storage layer and the photocatalyst layer.

3. The data storage disk of claim 1, wherein the photocatalyst layer comprises titanium dioxide.

4. The data storage disk of claim 1, wherein the photocatalyst layer oxidizes contaminants on the surface of the data storage disk when the photocatalyst layer is exposed to radiative energy.

5. The data storage disk of claim 4, wherein the radiative energy is a laser light used to read data from the data storage disk.

6. The data storage disk of claim 4, wherein the radiative energy is a laser light used to write data on the data storage disk.

7. The data storage disk of claim 4, wherein the radiative energy is a laser light used to erase data from the data storage disk.

8. The data storage disk of claim 4, wherein the radiative energy is ultraviolet light.

9. The data storage disk of claim 4, wherein the contaminants are organic.

10. The data storage disk of claim 4, wherein the contaminants include fingerprints.

11. A system comprising:
a hub sized to receive a data storage disk that includes a photocatalyst layer on a surface of the data storage disk;
a motor coupled to the hub that rotates the hub and the data storage disk; and
a radiative energy source that emits a radiative energy that activates the photocatalyst layer to clean the surface of the data storage disk.

12. The system of claim 11, wherein the photocatalyst layer oxidizes organic contaminants on the surface of the data storage disk when the photocatalyst layer is exposed to radiative energy.

13. The system of claim 11, wherein the radiative energy source is a laser used to read data from the data storage disk.

14. The system of claim 11, wherein the radiative energy source is an ultraviolet light.

15. The system of claim 11, further comprising a read component that is separate from the radiative energy source to read data from the data storage disk.

16. A method comprising:
determining contaminants are on a surface of a data storage disk, wherein the data storage disk includes a photocatalyst layer on the surface of the data storage disk; and
exposing the data storage disk to a radiative energy that activates the photocatalyst layer to clean the surface of the data storage disk

17. The method of claim 16, wherein determining the contaminants are on the surface of the data storage disk comprises:
attempting read data from the data storage disk; and
failing to read the data from the data storage disk.

18. The method of claim 17, further comprising:
waiting defined amount of time after exposing the data storage disk to the radiative energy; and
reattempting to read the data from the data storage disk.

19. The method of claim 16, wherein exposing the data storage disk to the radiative energy comprises activating a radiative energy source that emits the radiative energy.

20. The method of claim 19, wherein the radiative energy source is a laser light used to read data from the data storage disk.

21. The method of claim 19, wherein the radiative energy source is an ultraviolet light.

22. The method of claim 19, further comprising:
waiting a defined amount of time after activating the radiative energy source; and
deactivating the radiative energy source.
